(19) United States
(12) Patent Application Publication
(10) Pub. No.: US 2003/0168145 A1
(43) Pub. Date: Sep. 11, 2003

(54) Method and apparatus for mounting

(76) Inventors: Tadatomo Suga, Tokyo (JP); Akira Yamauchi, Shiga (JP); Yoshiyuki Arai, Shiga (JP); Chisa Inaka, Shiga (JP)

Correspondence Address: SMITH PATENT OFFICE, 1901 PENNSYLVANIA AVENUE N W, SUITE 200, WASHINGTON, DC, 20006

(21) Appl. No.: 10/344,931

(22) PCT Filed: Aug. 6, 2001
(86) PCT No.: PCT/JP01/06734

(30) Foreign Application Priority Data
Aug. 18, 2000 (JP) 2000-248653

(51) Int. Cl. B65C 1/00; B32B 31/00

(52) U.S. Cl. 156/60; 156/349; 156/358

(57) ABSTRACT

A method and an apparatus for mounting: the method for bonding a plurality of objects to each other, comprising the steps of disposing, apart from each other, a first object, a second object and a holding means therefor, and a backup member having a reference positioning surface in this order, adjusting the parallelism of the second object or the holding means therefor relative to the reference positioning surface, adjusting the parallelism of the first object or the holding means therefor relative to the second object or the holding means therefor, bringing the first object into contact with the second object to temporarily bond both objects to each other, bringing the holding means for the second object into contact with the reference positioning surface of the backup member, and pressing both objects against each other for final bonding, whereby, finally, a highly reliable and accurate bonding state can be achieved.

### TECHNICAL FIELD OF THE INVENTION

The present invention relates to mounting method and apparatus for bonding a plurality of objects such as wafers to each other.

### BACKGROUND ART OF THE INVENTION

When a plurality of objects such as wafers, chips and substrates are bonded to each other, a high accuracy in parallelism between both objects to be bonded is required immediately before bonding or at the time of bonding. Recently, the requirement of the accuracy has been increased, and a high accuracy up to submicrons has been required. Although various methods for achieving a high-accuracy alignment have been proposed, most of them aim to control the parallelism between objects within a predetermined accuracy immediately before bonding, and methods for adjusting or correcting the parallelism within a high accuracy during bonding are not found.

On the other hand, as a method for bonding objects to each other, Japanese Patent 2,791,429 discloses a room-temperature bonding method of silicon wafers for sputter etching the bonding surfaces of both silicon wafers by irradiating an inert gas ion beam or an inert gas high-speed atomic beam to the surfaces at a vacuum condition with a room temperature prior to the bonding. In this room-temperature bonding method, oxides or organic substances on the bonding surfaces of silicon wafers are removed by the above-described beam and the surfaces are formed by silicon atoms activated by the beam, and both surfaces are bonded to each other by a strong bonding force between the activated atoms. Therefore, in this method, basically, heating for bonding is not necessary, and it is possible to bond the surfaces at a room temperature merely by bringing the surfaces into contact with each other.

Even in this room-temperature bonding method, however, it is necessary to control the parallelism between objects to be bonded within a predetermined accuracy. Further, although it is possible to bond the surfaces activated as described above at a room temperature merely by bringing the surfaces into contact with each other, in a case where there are fine irregularities on the surfaces of the objects, especially in a case where concave portions are stacked to each other, there may occur a local fine gap because the strong bonding force between the activated atoms cannot operate at such a position. The presence of such a fine gap may damage the reliability of bonding.

### DISCLOSURE OF THE INVENTION

Accordingly, a purpose of the present invention is to provide method and apparatus for mounting which can obtain a final bonding state with an extremely high accuracy and a high reliability, and especially which can be adequately applied to an excellent room-temperature bonding method disclosed in the above-described Japanese Patent 2,791,429.

To achieve the above-described purpose, a mounting method according to the present invention for bonding a plurality of objects to each other comprises the steps of disposing, apart from each other, a first object, a second object and a holding means therefor, and a backup member having a reference positioning surface in this order; adjusting the parallelism of the second object or the holding means therefor relative to the reference positioning surface of the backup member; adjusting the parallelism of the first object or the holding means therefor relative to the second object or the holding means therefor; bringing the first object into contact with the second object to temporarily bond both objects to each other; bringing the holding means for the second object into contact with the reference positioning surface of the backup member; and pressing both objects against each other for final bonding.

Hereinafter, although mainly an embodiment wherein the backup member is fixed and the second object holding means is moved is explained, in the present invention it is also possible to employ an embodiment wherein the second object holding means is fixed and the backup member is moved.

Namely, in the mounting method according to the present invention, the preset reference positioning surface of the backup member is prepared as an absolute reference surface for adjusting parallelisms, the parallelism of the second object or the holding means therefor is adjusted relatively to the reference positioning surface, and the parallelism of the first object or the holding means therefor is adjusted relatively to the adjusted second object or holding means therefor. Therefore, at first, the positional relationships between the first object, the second object and the reference positioning surface of the backup member are adjusted within a target high-accuracy parallelism, respectively. At this state, first, the first object and the second object are brought into contact with each other and temporarily bonded. At the stage of the temporary bonding, the first object and the second object, particularly the second object holding means is still in a state apart from the reference positioning surface of the backup member, and after the temporary bonding, the temporarily bonded first and second objects are moved toward the reference positioning surface until the second object holding means comes into contact with the reference positioning surface of the backup member. Then, at a state where the second object holding means is brought into contact with the reference positioning surface, the first and second objects, which have been temporarily bonded, are finally bonded by pressing. Because this reference positioning surface of the backup member is set as an absolute reference surface for adjusting parallelisms, in the above-described pressing step, the parallelism between the first and second objects is forcibly corrected to a parallelism with a higher accuracy along this absolute reference surface. At the same time, even if there exist fine gaps ascribed to fine irregularity of a surface between the first and second objects having been temporarily bonded, the fine gaps can be buried by appropriate pressing, and an extremely reliable bonding state, in which substantially no fine gap exists, can be obtained.

In such a mounting method according to the present invention, a gap between the second object holding means and the reference positioning surface of the backup member after the adjustment in parallelism is adjusted preferably in a range of about 2 to 15 μm for example, and a gap between the first and second objects after the adjustment in parallelism and before the temporary bonding is adjusted preferably in a range of about 1 to 10 μm for example.

Further, as an alignment method for adjustment of parallelism, for example, a method can be employed wherein a recognition mark provided on the reference positioning surface of the backup member is read by a recognition means and a recognition mark provided on the second object or the holding means therefor is read by the recognition means, based on the result of reading the parallelism of the second object or the holding means therefor relative to the reference positioning surface of the backup member is adjusted, a recognition mark provided on the first object or the holding means therefor is read by the recognition means, and based on the result of reading the parallelism of the first object or the holding means therefor relative to the second object or the holding means therefor is adjusted. The recognition means is not particularly limited, but, for example, an infrared ray can be used as a measurement ray for reading the recognition marks by the recognition means.

For example, when the parallelism between objects being close to each other is adjusted, distances up to a plurality of recognition marks on both objects are measured using an automatic focusing function from outside by an infrared ray recognition means, and the parallelism is adjusted from differences between the distances up to the recognition marks on both objects.

Further, the above-described temporary bonding and final bonding may be carried out in a pressure-reduced gas atmosphere. Alternatively, the temporary bonding and final bonding may be carried out in a special gas atmosphere. The special gas in the present invention means, for example, an inert gas such as argon gas, a gas such as nitrogen gas which does not react with the objects, a gas which can replace the surface oxides to fluoro groups and the like on the surfaces of the objects, a gas which contains hydrogen and can react at a reducing condition on the surfaces of the objects, or a gas which contains oxygen and can remove carbons (organic substances) on the surfaces of the objects. If the temporary bonding and final bonding are carried out in such a special gas atmosphere, it becomes possible to suppress oxidation at the bonded portion between the objects and to prevent a reaction and adhesion of contamination which may obstruct the bonding.

Such a mounting method according to the present invention can be appropriately applied also to a room-temperature bonding method aforementioned. Namely, after the surfaces of both objects to be bonded to each other are cleaned by irradiating an energy wave or energy particle beam, the cleaned surfaces of both objects can be bonded to each other at a room temperature by the above-described method. As the used energy wave or energy particle beam, for example, a plasma (including an atmospheric-pressure plasma), an ion beam, an atomic beam, a radical beam or a laser can be employed. In case of such an application to a room-temperature bonding method, the cleaning may be carried out in a pressure-reduced gas atmosphere to increase the effect of the cleaning. However, when an enough effect can be obtained by the cleaning at an atmospheric pressure, the pressure reduction is not necessary.

Although the mounting method according to the present invention is effective for a case where at least one of the plurality of objects is a wafer, in particular, for a case where wafers are bonded to each other, of course, the present invention can be applied to other bonding of objects having any other forms such as a chip and a substrate, and to any other combination of objects. Moreover, the present invention can also be applied to a case where, after objects are bonded to each other, another object is further stacked and bonded thereonto in order, and in such a case, the above-described process may be repeated.

A mounting apparatus according to the present invention for bonding a plurality of objects to each other comprises means for holding a first object; means for holding a second object at a condition capable of being apart from the first object; a backup member having a reference positioning surface capable of being apart from the second object. The first object holding means, the second object holding means and the backup member are disposed in this order. The mounting apparatus further comprises a parallelism adjusting means for adjusting the parallelism of the second object or the holding means therefor relative to the reference positioning surface of the backup member and the parallelism of the first object or the holding means therefor relative to the second object or the holding means therefor; and a pressing means for bringing the first object into contact with the second object to temporarily bond both objects to each other and bringing the second object holding means into contact with the reference positioning surface of the backup member to press both objects against each other for final bonding.

In the mounting apparatus according to the present invention, the parallelism adjusting means can be constructed as means having a recognition means for reading recognition marks which are provided on the first object or the holding means therefor, the second object or the holding means therefor and the reference positioning surface of the backup member. The recognition means can be constructed as means having a two-sight camera or an infrared ray camera and the like.

If the backup member is constructed of a material which transmits a measurement ray for reading the recognition marks, it becomes possible to provide the recognition means at a position outside of the backup member. Such a structure is effective especially in a case where the bonding is carried out in a pressure-reduced atmosphere or in a special gas atmosphere such as an inert gas. The aforementioned infrared ray camera is preferable as the recognition means disposed outside. Of course, it is possible to use a recognition means which is provided so as to be proceeded to and retracted from a position between objects before bonding, for example, a two-sight camera. Further, it is also possible to use means for separatedly recognizing the first object side and the second object side, respectively.

Further, in the above-described mounting apparatus, a structure may be employed wherein at least the first object holding means, the second object holding means and the reference positioning surface of the backup member are provided in a bonding chamber capable of being closed. In this case, it is possible to attach a vacuum pump for reducing a pressure in the chamber to the bonding chamber, or to attach a gas replacing means for creating a special gas atmosphere, for example, an inert gas atmosphere or a gas atmosphere which does not react with the objects, to the bonding chamber.

Furthermore, the above-described mounting apparatus may have a cleaning chamber equipped with means for irradiating an energy wave or energy particle beam for cleaning the surfaces of both objects to be bonded to each other. In such a structure, the aforementioned room temperature bonding becomes possible. Moreover, even if the room temperature bonding is not required, because it becomes possible to remove the oxides and organic substances from the surfaces of the objects by irradiating the energy wave or energy particle beam, it becomes possible to maintain the surfaces of the objects before bonding to be in a clean condition, thereby achieving a more reliable bonding. As the energy wave or energy particle beam, for example, a plasma, an ion beam, an atomic beam, a radical beam or a laser can be used. Also to this cleaning chamber, a vacuum pump is attached for reducing a pressure in the chamber, and by the cleaning under the pressure-reduced condition, a further effective cleaning becomes possible. Further, it is also possible to attach a gas replacing means to the cleaning chamber for creating a special gas atmosphere in the chamber, for example, an inert gas replacing means for creating an inert gas atmosphere, and to carry out the cleaning under such a gas atmosphere condition. In a case where both the cleaning chamber and the bonding chamber are provided, it is preferred to provide a shutter means being opened and closed at a position between both chambers.

In the above-described mounting method and apparatus according to the present invention, an extremely high-accuracy and reliable bonding can be achieved finally by carrying out the temporary bonding at a condition adjusted in parallelism and thereafter carrying out the final bonding by pressing the temporarily bonded objects against the reference positioning surface of the backup member. Further, the mounting method and apparatus can be appropriately applied also to the room temperature bonding for cleaning the surfaces by irradiating the energy wave or energy particle beam prior to the bonding.

Further, even in a case where the surfaces of both objects are sufficiently cleaned, because the fine gaps or residual stress at an interface between both objects can be removed by heating, such a heating may be carried out together.

### BRIEF EXPLANATION OF THE DRAWINGS

FIG. 1 is a vertical sectional view of a mounting apparatus according to an embodiment of the present invention.

FIG. 2 is an enlarged partial side view showing the temporary bonding in the apparatus depicted in FIG. 1.

FIG. 3 is an enlarged partial side view showing the final bonding in the apparatus depicted in FIG. 1.

FIG. 4 is an enlarged partial sectional view showing gaps which may be formed between objects in the temporary bonding step.

### THE BEST MODE FOR CARRYING OUT THE INVENTION

Hereinafter, desirable embodiments of the present invention will be explained referring to figures.

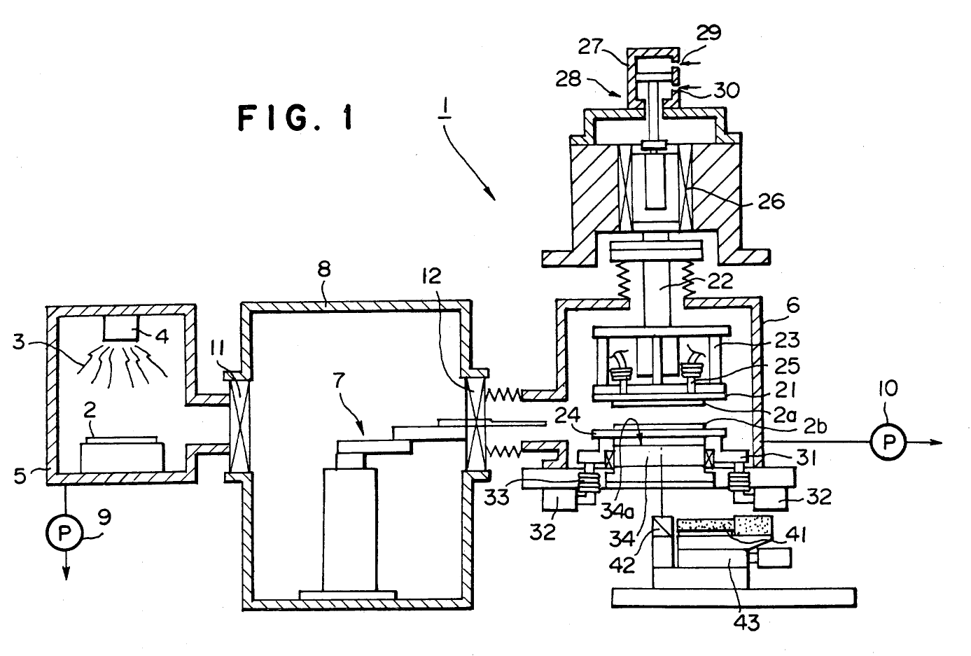

FIG. 1 shows a mounting apparatus according to an embodiment of the present invention. In FIG. 1, numeral 1 indicates the entire mounting apparatus, and FIG. 1 shows a case where wafers provided as objects are bonded to each other. In this embodiment, mounting apparatus 1 has a cleaning chamber 5 equipped with an energy wave irradiating means 4 (or an energy particle beam irradiating means) for irradiating an energy wave 3 onto the surfaces of the objects in order to clean the surfaces of wafers 2 provided as the objects to be bonded, a bonding chamber 6 for bonding a first object 2a and a second object 2b, and a conveying path 8 or a conveying chamber having a conveying robot 7 for conveying the cleaned first object 2a or first object 2a and second object 2b from the cleaning chamber 5 into the bonding chamber 6.

As the above-described energy wave or energy particle beam 3, as aforementioned, any of a plasma, an ion beam, an atomic beam, a radical beam and a laser is used. In this embodiment, in order to carry out the cleaning by the energy wave or energy particle beam 3 more effectively, a vacuum pump 9 is attached for reducing the pressure in cleaning chamber 5 at a predetermined vacuum degree. Instead of vacuum pump 9, or together with the vacuum pump 9, an inert gas replacing means may be provided for creating an inert gas atmosphere (for example, argon gas) in cleaning chamber 5 (not shown). The aforementioned room-temperature bonding becomes possible by cleaning the surfaces of the objects by irradiating such an energy wave or energy particle beam.

In this embodiment, a vacuum pump 10 is attached also to bonding chamber 6, and it is possible to reduce the pressure in the bonding chamber 6 at a predetermined vacuum degree. Instead of vacuum pump 10, or together with the vacuum pump 10, a gas replacing means may be provided for changing the gas atmosphere in bonding chamber 6 to an inert gas atmosphere or an atmosphere of a gas which does not react with the objects (for example, nitrogen gas) (not shown). By the bonding of the objects under a pressure-reduced condition, or by the bonding of the objects in an inert gas atmosphere, the oxidation of the bonding portions of the objects before bonding step can be effectively prevented, and a more reliable bonding state can be obtained.

Between cleaning chamber 5 and bonding chamber 6, in this embodiment, between cleaning chamber 5 and conveying path 8 and between the conveying path 8 and bonding chamber 6, shutter means 11 and 12 capable of being opened and closed are provided for communicating and interrupting the communication therebetween. By opening shutter means 11 and 12 only when conveyed by conveying robot 7 and closing at other times, the interiors of cleaning chamber 5 and bonding chamber 6 can be quickly formed as desirable gas atmospheres, and the desirable gas atmospheres can be maintained at the times of the respective treatments.

The portion for bonding objects including bonding chamber 6 is constructed as follows.

The means for directly holding first object 2a is formed from an electrostatic chuck 21, and the electrostatic chuck 21 is attached to the lower end of a head 22 capable of being moved vertically. A plurality of extend able supporting poles 23 are disposed on the lower portion of head 22, and by controlling the amounts of extension of the respective supporting poles 23, the parallelism of electrostatic chuck 21 relative to a lower-side electrostatic chuck 24, ultimately, the parallelism of first object 2a held on the electrostatic chuck 21 relative to second object 2b held on the lower-side electrostatic chuck 24, can be adjusted. Each extendable supporting pole 23 is formed as, for example, a pole incorporated with a piezoelectric element.

Further, light guides 25 for guiding lights irradiated toward an infrared-ray camera described later are provided on the lower portion of head 22. Each light guide 25 irradiates the light, which is guided from a light source (not shown) via optical fibers, etc., downward in the vertical direction. The portions of electrostatic chucks 21 and 24, through which the lights from light guides 25 are transmitted, are formed from a transparent material capable of transmitting a light, or holes for transmitting lights are opened.

A vertical movement mechanism 26 is provided above head 22, and thereabove, a pressing means 28 having a pressing cylinder 27 such as an air cylinder is provided. In the pressing cylinder 27, provided are a pressing port 29 for controlling a pressing force in the downward direction and a balance port 30 for controlling the pressing force and generating a moving force in the upward direction. Vertical movement mechanism 26 can move first object 2a held on electrostatic chuck 21 downwardly, and after the movement and the adjustment in parallelism, it can bring the first object 2a into contact with second object 2b and temporarily bond them. Further, pressing port 29 can add a pressing force via vertical movement mechanism 26 at the time of the temporary bonding, and after the temporary bonding, it can further press first object 2a, which has been moved downward, onto second object 2b, and can finally bond them by the pressing.

Second object 2b is held on lower-side electrostatic chuck 24. The electrostatic chuck 24 is provided on a stage 31, and the stage 31 is held on a position adjusting table 32, which is provided as a position adjusting means, via spring means 33. The spring means 33 comprises means exhibiting a constant length when a pressing force does not act from the upper side. Position adjusting table 32 can adjust the parallelisms and the vertical positions of stage 31 and electrostatic chuck 24 held thereon relative to a horizontal plane, thereby adjusting the parallelism and the vertical position of second object 2b held on the electrostatic chuck 24 relative to first object 2a.

A backup glass member 34, which is provided as a backup member and made of a glass transmitting a measurement wave for an infrared-ray camera described later, is provided below electrostatic chuck 24. The upper surface of backup glass member 34 faces the lower surface of electrostatic chuck 24, and this upper surface of backup glass member 34 forms a reference positioning surface 34a defined in the present invention. Electrostatic chuck 24, which is supported at a floating condition via the above-described spring means 33, is translated in parallel down to the reference positioning surface 34a by pressing from upper side.

An infrared-ray camera 41 is provided as recognition means below backup glass member 34 at a position outside of bonding chamber 6. Infrared-ray camera 41 can read the recognition marks provided for alignment on first object 2a or electrostatic chuck 21, the recognition marks provided on second object 2b or electrostatic chuck 24 and the recognition marks provided on reference positioning surface 34a of backup glass member 34, respectively, via a prism device 42 and using the light irradiated from light guide 25. The positions of infrared-ray camera 41 and prism device 42 can also be adjusted and controlled via position adjusting means 43.

The mounting method according to the present invention is carried out as follows, using the mounting apparatus 1 thus constructed.

First object 2a the surface of which has been cleaned in cleaning chamber 5, as the case may be, also second object 2b, is conveyed into bonding chamber 6 by conveying robot 7, the first object 2a is held on the lower surface of electrostatic chuck 21 after being turned over, and the second object 2b is held on the upper surface of electrostatic chuck 24. Shutter means 12 is closed and the interior of bonding chamber 6 is controlled at a predetermined vacuum degree by vacuum pump 10.

The parallelism between the lower surface of electrostatic chuck 24 and reference positioning surface 34a of backup glass member 34 is adjusted by position adjusting means 32, and the gap therebetween is adjusted in a range of 2 to 15 μm. Next, the parallelism of first object 2a relative to the adjusted second object 2b is adjusted by controlling the extension of the respective supporting poles 23, and the gap therebetween is adjusted in a range of 1 to 10 μm.

In these adjustments in parallelism, at first, the position of the recognition mark provided on reference positioning surface 34a of backup glass member 34 is read by infrared-ray camera 41, and then the recognition mark provided on the lower surface of electrostatic chuck 24 (as the case may be, the recognition mark provided on second object 2b) is read similarly, and the positions of the electrostatic chuck 24 and the second object 2b held thereon relative to reference positioning surface 34a are controlled to predetermined positions and the parallelism therebetween is adjusted. Next, the recognition mark provided on first object 2a or electrostatic chuck 21 is read, the parallelism of the first object 2a or electrostatic chuck 21 relative to the adjusted second object 2b or electrostatic chuck 24 is adjusted and positioning is carried out. When each recognition mark is read, a known automatic focusing function can be utilized, and infrared-ray camera 41 may be appropriately moved via position adjusting means 43.

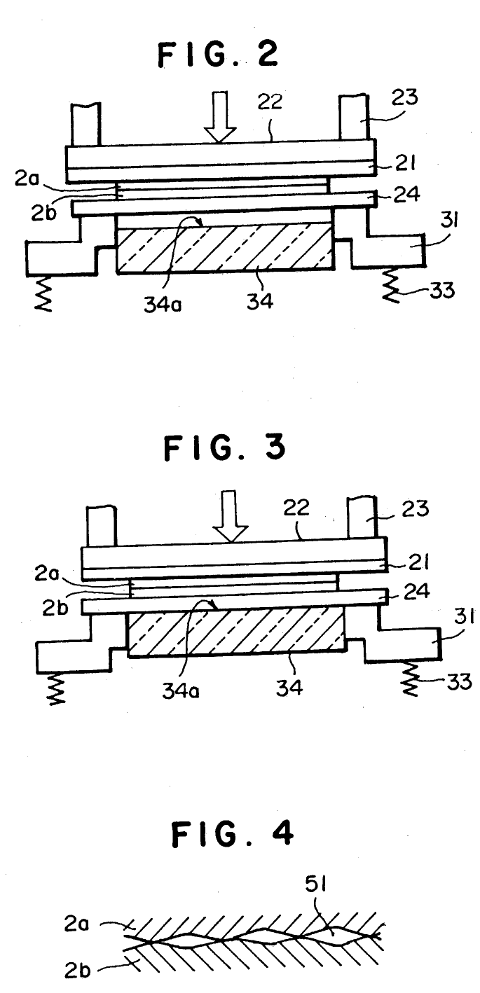

After the above-described adjustment in parallelism, as shown in FIG. 2, head 22 is moved down by operating pressing means 28, and first object 2a is brought into contact with second object 2b to temporarily bond both objects. In this temporary bonding step, a gap such as one aforementioned exists between the lower surface of electrostatic chuck 24 holding second object 2b and reference positioning surface 34a of backup glass member 34, and the electrostatic chuck 24 is in a condition of being apart. Further, when there exist fine irregularities on the surfaces to be bonded of the objects, as shown in FIG. 4, fine gaps 51 may occur between first object 2a and second object 2b to be bonded to each other. As aforementioned, by cleaning due to irradiation of the energy wave or energy particle beam, basically it is possible to bond both surfaces at a room temperature only by bringing the surfaces into contact with each other, but, when gaps 51, having a degree at which the bonding force between atoms does not act, are generated, the room-temperature bonding cannot be achieved at such gap portions. For example, there is such a fear when a gap 51 with about 10 nm or more is generated.

In the method according to the present invention, however, such a gap 51 can be buried substantially completely by the final bonding after the temporary bonding. As shown in FIG. 3, after the above-described temporary bonding, head 22 is further moved down by operating pressing means 28, first object 2a and second object 2b, which are in a temporarily bonded condition, are pressed downward together with stage 31 and lower-side electrostatic chuck 24 which are elastically supported at a floating condition by spring means 33, and the lower surface of the electrostatic chuck 24 is brought into contact with reference positioning surface 34a of backup glass member 34. In this condition, the bonding surfaces of first object 2a and second object 2b are pressed to each other at a predetermined pressing force by pressing means 28. The gaps 51 as shown in FIG. 4 are completely buries by adding an appropriate pressing force, and the first object 2a and second object 2b are finally bonded to each other at a desirable condition, namely, at an extremely reliable formation.

In the above-described temporary bonding, because the parallelism between first object 2a and second object 2b has been already adjusted at a high accuracy immediately before the temporary bonding, the temporary bonding can be carried out at a high accuracy, and when bonded finally, because both objects temporarily bonded at a high accuracy are merely translated in parallel as they are and the parallelism between electrostatic chuck 24 and reference positioning surface 34a has been already adjusted at a high accuracy, the final bonding by pressing is also carried out at a high-accuracy parallelism. Furthermore, since this reference positioning surface 34a of backup glass member 34 is set as an absolute reference surface for positioning by initial setting and the lower surface of electrostatic chuck 24 is forcibly pressed so as to follow the reference positioning surface 34a (so as to come into close contact therewith), ultimately, the final bonding is carried out with an extremely accurate parallelism relative to the reference positioning surface 34a. By such a high-accuracy final bonding, an extremely reliable bonding state can be achieved.

When objects to be bonded to each other are pressed on a usual alignment table, because a deflection occurs, for example, on a ball-slide guide portion, it is difficult to support them at a sufficiently high rigidity while maintaining a desirable positional accuracy. In the present invention, however, by forming backup glass member 34 with reference positioning surface 34a as a separate member and giving thereto a sufficiently high rigidity, a high-accuracy reference positioning surface 34a without deflection can be formed and maintained as a backup reference positioning surface, and an extremely high-accuracy bonding becomes possible.

Although an infrared-ray camera is used for alignment and adjustment in parallelism in the above-described embodiment, because a visual ray can be used for adjustment in parallelism, a usual visual-ray camera may be employed.

### INDUSTRIAL APPLICATIONS OF THE INVENTION

The mounting method and apparatus according to the present invention can be applied to any bonding of objects represented by bonding of wafers, and by applying the present invention, an extremely reliable bonding can be achieved with an extremely high accuracy. Further, the mounting method and apparatus according to the present invention can also be appropriately applied to a room-temperature bonding in which the cleaning due to the irradiation of an energy wave or energy particle beam is carried out prior to the bonding.

1. A mounting method for bonding a plurality of objects to each other comprising the steps of:
disposing, apart from each other, a first object, a second object and a holding means therefor, and a backup member having a reference positioning surface in this order;
adjusting the parallelism of said second object or the holding means therefor relative to said reference positioning surface of said backup member;
adjusting the parallelism of said first object or the holding means therefor relative to said second object or the holding means therefor;
bringing said first object into contact with said second object to temporarily bond both objects to each other;
bringing the holding means for said second object into contact with said reference positioning surface of said backup member; and
pressing both objects against each other for final bonding.

2. The mounting method according to claim 1, wherein a gap between the holding means for said second object and said reference positioning surface of said backup member after said adjustment in parallelism is adjusted in a range of 2 to 15 μm, and a gap between said first and second objects after said adjustment in parallelism and before said temporary bonding is adjusted in a range of 1 to 10 μm.

3. The mounting method according to claim 1, wherein a recognition mark provided on said reference positioning surface of said backup member is read by a recognition means and a recognition mark provided on said second object or the holding means therefor is read by said recognition means, based on the result of reading the parallelism of said second object or the holding means therefor relative to said reference positioning surface of said backup member is adjusted, a recognition mark provided on said first object or the holding means therefor is read by said recognition means, and based on the result of reading the parallelism of said first object or the holding means therefor relative to said second object or the holding means therefor is adjusted.

4. The mounting method according to claim 3, wherein an infrared ray is used as a measurement ray for reading said recognition marks by said recognition means.

5. The mounting method according to claim 4, wherein, when the parallelism between objects being close to each other is adjusted, distances up to a plurality of recognition marks on both objects are measured using an automatic focusing function from outside by an infrared ray recognition means, and the parallelism is adjusted from differences between the distances up to the recognition marks on both objects.

6. The mounting method according to claim 1, wherein said temporary bonding and said final bonding are carried out in a pressure-reduced gas atmosphere.

7. The mounting method according to claim 1, wherein said temporary bonding and said final bonding are carried out in a special gas atmosphere.

8. The mounting method according to claim 1, wherein the surfaces of both objects to be bonded to each other are cleaned by an energy wave or energy particle beam, and thereafter, the cleaned surfaces of both objects are bonded to each other at a room temperature.

9. The mounting method according to claim 8, wherein a plasma, an ion beam, an atomic beam, a radical beam or a laser is used as said energy wave or energy particle beam.

10. The mounting method according to claim 8, wherein said cleaning is carried out in a pressure-reduced gas atmosphere.

11. The mounting method according to claim 1, wherein at least one of said plurality of objects is a wafer.

12. A mounting apparatus for bonding a plurality of objects to each other comprising:
means for holding a first object;
means for holding a second object at a condition capable of being apart from said first object;
a backup member having a reference positioning surface capable of being apart from said second object, said first object holding means, said second object holding means and said backup member being disposed in this order;
a parallelism adjusting means for adjusting the parallelism of said second object or the holding means therefor relative to said reference positioning surface of said backup member and the parallelism of said first object or the holding means therefor relative to said second object or the holding means therefor; and
a pressing means for bringing said first object into contact with said second object to temporarily bond both objects to each other and bringing said second object holding means into contact with said reference positioning surface of said backup member to press both objects against each other for final bonding.

13. The mounting apparatus according to claim 12, wherein said parallelism adjusting means has a recognition means for reading recognition marks which are provided on said first object or the holding means therefor, said second object or the holding means therefor and said reference positioning surface of said backup member.

14. The mounting apparatus according to claim 13, wherein said recognition means has an infrared ray camera.

15. The mounting apparatus according to claim 13, wherein said backup member is constructed of a material which transmits a measurement ray for reading said recognition marks, and said recognition means is provided outside of said backup member.

16. The mounting apparatus according to claim 13, wherein said recognition means is provided so as to be proceeded to and retracted from a position between both objects before bonding.

17. The mounting apparatus according to claim 12, wherein at least said first object holding means, said second object holding means and said reference positioning surface of said backup member are provided in a bonding chamber capable of being closed.

18. The mounting apparatus according to claim 17, wherein a vacuum pump is attached to said bonding chamber for reducing a pressure in the chamber.

19. The mounting apparatus according to claim 17, wherein a gas replacing means is attached to said bonding chamber for creating a special gas atmosphere in the chamber.

20. The mounting apparatus according to claim 12, wherein said apparatus has a cleaning chamber equipped with means for irradiating an energy wave or energy particle beam for cleaning the surfaces of both objects to be bonded to each other.

21. The mounting apparatus according to claim 20, wherein a plasma, an ion beam, an atomic beam, a radical beam or a laser is used as said energy wave or energy particle beam.

22. The mounting apparatus according to claim 20, wherein a vacuum pump is attached to said cleaning chamber for reducing a pressure in the chamber.

23. The mounting apparatus according to claim 20, wherein a gas replacing means is attached to said cleaning chamber for creating a special gas atmosphere in the chamber.

24. The mounting apparatus according to claim 20, wherein a shutter means being opened and closed is provided between said cleaning chamber and said bonding chamber.

25. The mounting apparatus according to claim 12, wherein at least one of said plurality of objects is a wafer.
